(19) United States
(12) Patent Application Publication
(10) Pub. No.: US 2002/0022189 A1
(43) Pub. Date: Feb. 21, 2002

(54) Toner for developing electrostatic charge image and image forming apparatus using the same

(75) Inventors: Tsuneaki Kawanishi, Ibaraki (JP); Ryuuichi Shimizu, Ibaraki (JP); Shigenori Yaguchi, Ibaraki (JP); Katsuya Kawai, Ibaraki (JP); Nobuyoshi Hoshi, Ibaraki (JP); Akira Hosoya, Ibaraki (JP)

Correspondence Address: SUGHRUE, MION, ZINN, MACPEAK & SEAS, PLLC, 2100 Pennsylvania Avenue, N.W., Washington, DC, 20037-3202, US

(73) Assignee: HITACHI KOKI CO., LTD.

(21) Appl. No.: 09/944,202

(22) Filed: Sep. 4, 2001

Related U.S. Application Data
(63) Continuation-in-part of application No. 09/578,495, filed on May 26, 2000.

(30) Foreign Application Priority Data
May 28, 1999 (JP) P. HEI.11-149523
May 28, 1999 (JP) P. HEI.11-149524

(51) Int. Cl. G03G 9/08

(52) U.S. Cl. 430/108.8

(57) ABSTRACT

Toner for developing an electrostatic charge image comprises: polyethylene wax having a value (Mw/Mn) of weight average molecular weight/number average molecular weight which is larger than 1.5, melt viscosity lower than 10 mPa•s at 140° C., and degree of crystallinity lower than 90%.

Toner for developing electrostatic charges comprises the fixing resin which contains a vinyl copolymer polymerized in the presence of polyethylene wax obtained by refining a low-grade polymer of polyethylene prepared by a medium-or low-pressure method.

### BACKGROUND OF THE INVENTION

1. Field of the Invention

The present invention relates to toner for developing an electrostatic charge image for visualizing an electrostatic latent image formed by an electrophotographic method, an electrostatic printing method, an electrostatic recording method or the like and an image forming apparatus using the toner.

2. Description of the Related Art

For example, the electrophotographic method among the electrophotographic method, the electrostatic printing method and the electrostatic recording method is arranged such that a surface of a photoconductive photosensitive member serving as an electrostatic-charge holding member is changed and exposed so that an electrostatic latent image is formed on the photosensitive member. Then, the electrostatic latent image is developed by using fine-grain toner containing coloring matter in which resin serves as a binder. The obtained toner image is transferred to a recording medium, such as a paper sheet, and then the toner image is fixed. Thus, a recorded image is obtained.

The foregoing steps for recording the electrostatic latent image incorporate important steps, that is, a step for developing an electrostatic latent image by using fine-grain toner and a step for fixing the toner image to the recording medium. As a development method, a magnetic brush development method is usually employed which uses a binary developer incorporating toner capable of realizing high-speed and high-quality development and a magnetic carrier. As a fixing method, a heated-roller method is widely used which exhibits high thermal efficiency and which permits a high-speed fixing operation.

Recently considerable progress of pieces of information apparatus results in development of a laser beam printer arranged to use a laser beam to expose a photoconductive photosensitive member to reproduce a recorded image with dots in response to a modulation signal generated in accordance with an instruction issued from a computer. In particular, a laser beam printer developed recently must record an image having a high quality image quality. Therefore, the diameter of the laser beam is reduced to realize a high dot density of 600 dpi (dots/inch) to 1200 dpi. It leads to a fact that also the particle size of each of the toner and the carrier has been reduced. Therefore, fine-grain toner having a volume average particle size of 10 μm or smaller and a fine-grain carrier having a weight average particle size of 100 μm or smaller have been employed.

On the other hand, the heated-roll fixing method is widely used to fix the toner image. In the foregoing case, the following requirements must be satisfied: prevention of overheat of the printer and deterioration in the elements of the printer; shortening of warmup time required to perform the fixing operation from start of the operation of the fixing unit; prevention of defective fixing caused from a fact that heat is absorbed by the recording medium to enable the image quality during successive paper supply; prevention of occurrence of a curl and fire caused from overheat; and reduction in the load which is exerted on the heated roller to simplify the structure of the fixing unit and reduce the size of the same. Therefore, development of toner has been required with which the temperature of the heated roller can be lowered and the pressure for fixing the toner image can as well as be lowered. As described above, development of toner has been required which is composed of fine grains and with which an image can be fixed at a low temperature and a low pressure.

When the toner is formed into fine grains having a particle size of 10 μm or smaller, the following problems arise. Although high image quality can be obtained when the fine-grain toner is used in the development process, adhesion of the toner (fogging) to a non-image portion and scattering of the toner easily take place. Moreover, deterioration in the fluidity easily causes the handling easiness, for example, easy carrying of toner to deteriorate.

Moreover, excessively large adhesiveness and unsatisfactory impact resistance of the fine-grain toner result in easy occurrence of carrier contamination (carrier spent). It leads to a fact that the life of the developer is easily shortened.

To obtain the same fixing strength, greater energy is required as compared with toner having a large particle size when fixing is performed. When the toner is manufactured, manufacturing yield in a crushing step and that in a classifying step deteriorate. As a result, the cost of the toner cannot be reduced. The fine-grain toner suffers from the many problems. Therefore, the toner having a particle size smaller than 5 μm cannot easily be put into practical use. Therefore, classification of the particle size of the toner is performed to realize a particle size of 6 μm to 10 μm. Moreover, coating additives and method of adding the coating additive have been improved to improve the fluidity of the toner. As for the carrier, the weight average particle size is reduced to 100 μm or smaller since the particle size of the toner has been reduced. Thus, the specific surface area of the carrier is enlarged so as to improve the frictional electrification with respect to the toner. Carriers of a type having a particle size smaller than 40 μm, however, encounters reduction in the magnetic force of the carrier. In the foregoing case, the carrier easily adheres to the surface of the electrostatic image holding member. Therefore, classification of the mean particle size of the carrier is performed to realize a particle size of 40 μm to 100 μm. If necessary, the surface of the carrier is coated with resin.

Since the grain size distribution, the fluidity and the electrification easiness have been improved as described above, the fine-grain toner and the developer have been put into practical use in the image forming apparatus. When high speed printing for printing 10 or more pages per minute is repeated, the problems specific to the fine-grain toner arise. That is, the carrier spent caused by the toner frequently results in shortening of the life of the developer. Moreover, filming of the photosensitive member caused by the toner results in easy occurrence of shortening of the life of the photosensitive member. What is worse, required strength for fixing an image cannot easily be obtained. In particular, the temperature and the pressure of the heated roller must be raised in the fixing step. As a result, there arises a problem in that the reliability of the fixing unit cannot be improved, the size of the same cannot be reduced, the structure cannot be simplified and the cost cannot be reduced.

To improve the performance of the toner, addition of wax to the fixing resin is a known fact as disclosed in, for example, JP-A-52-3304, JP-A-52-3305 and JP-A-57-52574. The waxes are employed to prevent adhesion of the toner to the heated roller when the temperature is low or high, that is, so-called an offset phenomenon so as to improve fixing facility of the toner when the temperature is low. Recently, low melting point wax has attracted attention from a viewpoint of low-temperature fixing.

To improve the characteristic for fixing the toner at a low temperature, offset resistance and a non-coagulation characteristic, a method has been disclosed in JP-A-5-313413. That is, a copolymer of ethylene or propylene having viscosity of 10,000 poise or lower at 140° C. and α-olefin is added to a vinyl copolymer having a specific molecular weight distribution.

To achieve a similar object, addition of paraffin wax having a peak (a melting point) of the absorption heating value of 75° C. to 85° C. measured by a differential scanning calorimeter (DSC) has been disclosed in JP-A-7-287413. In JP-A-8-314181 and JP-A-9-179355, addition of natural gas Fischer-Tropsch wax having a melting point of 85° C. to 100° C. measured by the DSC has been disclosed. In JP-A-6-324513, addition of polyethylene wax having a melting point of 85° C. to 110° C. measured by the DSC has been disclosed.

In JP-A-7-36218, addition of polyethylene wax from which components having a melting point of 50° C. or lower have been removed by a distillation method and which has a DSC melting point of 70° C. to 120° C. has been disclosed. In JP-A-8-114942, addition of polyethylene having a weight average molecular weight (Mw) which is smaller than 1,000 has been disclosed.

When a wax having a low melting point is added, the heat resistance, durability and preservation stability deteriorate. To improve the foregoing disadvantages, employment of a wax having weight average molecular weight/number average molecular weight of 1.5 or lower has been disclosed in JP-A-6-123994. In JP-A-7-209909, employment of ethylene-olefin polymer wax having a melting viscosity of 0.5 mPa•s to 10 mPa•s at 140° C. and a penetration of 3.0 dmm or smaller has been disclosed. In JP-A-7-287418, employment of Fischer-Tropsch having an average molecular weight of 1,000 or greater has been disclosed.

Although the fixing performance of the toner can be improved by using the conventional techniques, employment of the wax having the low melting point, in particular, employment of the fine-grain toner faces the difficulty in improving the fixing performance in state where the required fluidity, the heat resistance, the durability and the preservation stability. Therefore, toner and an image forming apparatus which can be put into practical use cannot be provided.

### SUMMARY OF THE INVENTION

An object of the present invention is to provide toner excellent in the fluidity, heat resistance, durability and the preservation stability and capable of reducing the energy required to fix the toner and an image forming apparatus using the toner.

The foregoing object can be achieved by obtaining toner for developing electrostatic charges comprising:

polyethylene wax having a value (Mw/Mn) of weight average molecular weight/number average molecular weight which is larger than 1.5, melt viscosity lower than 10 mPa•s at 140° C., and degree of crystallinity lower than 90%.

The foregoing object can be achieved by obtaining an image forming apparatus comprising: development means for supplying toner arranged to develop electrostatic charges and containing fixing resin and polyethylene wax having a value (Mw/Mn) of weight average molecular weight/number average molecular weight which is larger than 1.5, melt viscosity lower than 10 mPa•s at 140° C., and degree of crystallinity lower than 90% to an electrostatic-charge holding member holding an electrostatic latent image to visualize the electrostatic latent image into a toner image; transfer means for transferring the toner image formed on the electrostatic-charge holding member to a recording medium; and fixing means for fixing the toner image to the recording medium by supplying at least heat to the recording medium holding the toner image.

### BRIEF DESCRIPTION OF THE DRAWINGS

FIG. 1 is an overall structural view showing a laser beam printer to which the present invention is applied.

### DETAILED DESCRIPTION OF THE PRESENT INVENTION

In general, resin for fixing toner is styrene-(metha) acrylic resin or polyester resin serving to fix the toner to the heated roller. In general, polyester resin contains polar groups (hydroxyl groups or carboxylic groups) having high water absorption. Thus, the toner easily absorbs moisture, causing the electrification characteristic of the toner to easily be changed. Recently, resin obtained by graft-copolymerizing the polyester resin and styrene-acryl and having a low moisture absorption has been developed. The waxes are added to the foregoing fixing resins to improve the fixing performance of the toner.

The waxes have been employed as materials for preventing offset of the toner. On the other hand, the fluidity, the heat resistance, the durability and the preservation stability of the toner deteriorate, causing a problem to arise in that undesirable melt deposit easily occur. There are a variety of waxes so as to selectively be used to satisfy a purpose. To prevent offset of the toner, nonpolar polyethylene wax of a type which is noncohesive the heated roller is an optimum wax.

The polyethylene wax is an aggregate of polyethylene molecules, the molecular weights of which are distributed. The characteristics of the polyethylene wax greatly depend on the distribution of the molecular weights. In general, the polyethylene wax having the effect of preventing offset occurring when the temperature is high furthermore attains an effect of preventing offset at low temperatures and improving the fixing easiness at low temperatures when the quantity of the components having low molecular weights is enlarged.

When the quantity of the components having the low molecular weights is enlarged to improve the fixing performance, the heat resistance, the durability and the preservation stability of the toner, however, deteriorate. What is worse, undesirable melt deposit to the carrier of the developer and the photosensitive member easily occur. Therefore, an attempt has been made to sharpen the distribution of the molecular weights by extremely reducing the components having low molecular weights of the conventional polyethylene wax. That is, the weight average molecular weight/number average molecular weight (Mw/Mn) in the distribution of molecular weights which can be measured by gel permeation chromatography (GPC) is made to be 1.5 or lower, preferably 1.45 or lower to sharpen the distribution of the molecular weights of the wax.

Investigations performed by the inventors of the present invention have resulted in that sharpening of the distribution of the molecular weights of the polyethylene wax causes the fixing performance to deteriorate in spite of improvement in the fluidity, the heat resistance, the durability and the preservation stability of the toner. In particular, the fixing performance of the fine-grain toner deteriorates when a high speed printing operation at 10 pages/minute or higher is repeated.

Therefore, the inventors of the present invention have evaluated the various characteristics such that a polyethylene wax properly containing components having low molecular weights and having a weight average molecular weight/number average molecular weight (Mw/Mn) of 1.5 or higher (preferably, higher than 1.5 and not higher than 2.0) has been added to the toner. As a result, when the melt viscosity at 140° C. is lower than 10 mPa•s (preferably lower than 9 mPa•s, more preferably higher than 8 mPa•s and lower than 9 mPa•s) and a degree of crystallinity measured by x-ray diffraction method is lower than 90% (preferably higher than 75% and lower than 90%, more preferably not lower than 80% and not higher than 85%) and the melting point defined by a maximum peak of an absorbed heating value curve of a DSC curve measured by a differential scanning calorimeter when the temperature is raised, satisfys a range from 70° C. to 110° C., satisfactory fixing performance of the toner can be obtained. Moreover, satisfactory fluidity, heat resistance, durability and preservation stability of the toner can be obtained. In addition, shortening of the life of the developer which occurs when carrier spent is caused by the toner can be prevented. Moreover, shortening of the life of the photosensitive member occurring when filming of the photosensitive member is caused by the toner can be prevented. Thus, a fact has been detected that a stable electrostatic toner image can be recorded. When the melt viscosity and the degree of crystallinity increases to exceed the above ranges, sufficient fixing performance and resistance of off set cannot be obtained in high speed fixing with the fine-grain toner. A proper amount of the polyethylene wax according to the invention is added to the fixing resin, and whereby the fixing performance of the toner can be increased greatly. However, since the polyethylene wax according to the invention has large molecular weight distribution and low viscosity, in case of adding the polyethylene wax to the toner, the heat resistance, the durability and the preservation stability of the toner are apt to deteriorate. In order to prevent these characteristics from deteriorating, it is necessary to adjust the molecular weight distribution of the wax so that the melt viscosity of the polyethylene wax at 140 ° C. is higher than 5 mpa•s and the degree of crystallinity of the polyethylene measured by the x-ray diffraction method is higher than 75%.

As a method of improving a dispersion characteristic of the wax into the toner, a method may be employed with which the energy for thermally fusing and kneading the toner is enlarged to improve the miscibility between the wax and the fixing resin. The foregoing method, however, encounters a fact that the fixing resin sustains mechanical damage when sufficiently large energy capable of improving the dispersion characteristic of the wax is supplied to the wax resin, that is mixture of the wax and the fixing resin. In the foregoing case, the fixing characteristic and high-temperature offset resistance deteriorate.

As another method of improving the dispersion characteristic of the wax, a coexistence polymerizing method has been disclosed in JP-A-5-313413, JP-A-9-281748 and JP-A-9-304966. In the foregoing disclosures, wax is caused to coexist in the overall portion or a portion of the step for preparing the wax resin. When the foregoing coexistence method has been investigated, the uniform dispersion of the wax in the wax resin is permitted without any deterioration in the resin. When the fixing resin obtained by the foregoing method has been contained in the toner, the fluidity, the heat resistance, the durability and the preservation stability of the toner can be improved. Moreover, shortening of the life of the developer caused from carrier spent occurring due to the transmission and that of the life of the photosensitive member caused from filming of the photosensitive member occurring due to the transmission can be prevented. Therefore, a stable electrostatic toner image can be recorded and formed.

In the present invention, the components having low molecular weights are properly contained in the polyethylene wax to widen the distribution of the molecular weights. To obtain satisfactory fixing characteristic and offset resistance, the distribution of the molecular weights must be controlled in such a manner that the melt viscosity of the polyethylene wax is 10 mPa•s or lower at 140° C. When the melt viscosity of the polyethylene wax is raised and deviated from the foregoing range, satisfactory fixing characteristic and offset resistance cannot be obtained in a high-speed fixing operation using the fine-grain toner.

On the other hand, to maintain satisfactory heat resistance, durability and the preservation stability of the toner, the DSC melting point of the polyethylene wax must satisfy a range from 70° C. to 110° C. When the melting point of the polyethylene wax is lower than 70° C., snortening of the life of the developer occurs due to the carrier spent caused from the toner. What is worse, shortening of the life of the photosensitive member takes place due to filming of the photosensitive member caused from the toner. When the melting point of the polyethylene wax is higher than 110° C., the fixing characteristic and the offset resistance of the toner deteriorate.

The polyethylene wax according to the present invention can be obtained by refining a low-grade polymer of polyethylene prepared by a medium-or low-pressure polyethylene polymerizing method industrially using a Ziegler catalyst or a metallocene catalyst. That is, oil contents, oligomer and so forth are removed from the low-grade polymer of polyethylene by a vacuum distillation method. Then, obtained residual distillate solution is subjected to a process for properly removing the components having low molecular weights at a high temperature and a reduced pressure.

The polyethylene wax is exemplified by Neowax L, AL, LS, CL, ACL and the like which are trade names of Yasuhara Chemical.

In the present invention, the distribution of the molecular weight of polyethylene wax is measured by GPC under the following conditions.

Conditions under which GPC Measurement is Performed

Apparatus: ALC/GPC 150-C (manufactured by Waters)

Separation Column: GMH-HT 60 cm×1, GMH-HTL 60 cm×1 (manufactured by Toso)

Temperature of Column: 135° C.

Moving Phase: o-dichlorobenzene

Detector: differential refractometer

Flow Rate: 1.0 liter/minute

Concentration of Sample: 0.15 wt. %

Amount of Injection: 400 μliter

The measurement is performed under the foregoing conditions. When the molecular weight of each sample is calculated, a molecular weight calibration curve produced by using a monodisperse polystyrene standard sample is used. A conversion equation derived from Mark-Houwink-Sakurada's equation or a viscosity equation is used to perform conversion to polyetylene.

In the present invention, the melt viscosity of the wax is measured by using a Brookfield viscometer to read a value realized at 140° C. The degree of crystallinity of the wax is measured under the following conditions.

X-ray: Cu-Kα ray (made be monochrome by graphite monochrometor)

wavelength: λ=1.5406 Å

output: 40 kV, 40 mA

optical system: reflection method, slit DS, SS=1°, RS=0.3 mm

measurement range: 2θ=10°˜35°

step interval: 0.02°

scanning speed: 2θ/θ continued scan 1.00°/minute The measurement is performed under the above conditions, and x-ray diffraction profile of a sample is separated into three crystal peaks and amorphous diffraction, and then the degree of crystallinity is calculated by the following equation.

degree of crystallinity (%)=Ic/(Ic+Ia)_x_{—}100

where Ic is sum of areas of crystal peaks and Ia is sum of areas of crystal peaks+area of amorphous diffraction. When DSC measurement is performed, exchange of heat of the wax is measured to observe the behavior. Therefore, it is preferable that the measurement is performed by an accurate heat flux type differential scanning calorimeter is employed because of the principle of the measurement. For example, a differential scanning calorimeter 2910 manufactured by TA instruments may be employed. The measurement is performed under conditions that polyethylene wax is weighed by about 5 mg so as to be placed on the DSC. Then, nitrogen gas is introduced at 50 ml/minute, and then the temperature is raised from 20° C. to 160° C. at a rate of 10° C./minute. Then, the temperature is decreased from 160° C. to 20° C. at about a rate of 10° C./min to remove previous hysteresis. Then, the temperature is raise at a rate of 10° C./minute so as to obtain the melting point of the wax corresponding to a maximum value of endotherm peak of the wax in accordance with the maximum peak of the DSC absorbed heating value curve.

As for the other physical properties of the polyethylene wax, it is preferable that the penetration at 25° C. is smallest. Since the wax having the wide distribution of the molecular weight according to the present invention properly contains the components having low molecular weights, the penetration measured in conformity with JIS-K-2207 is 3 to 10.

It is preferable that the quantity of the polyethylene wax to be added to the toner according to the present invention is 0.5 wt. % to 20 wt. % with respect to the fixing resin. When the quantity is lower than 0.5 wt. %, a satisfactory effect to improve the performance for fixing the toner cannot be obtained. When the quantity is higher than 20 wt. %, high-temperature offset of the toner easily occurs. Although simultaneous use with other waxes is permitted, an attention must be paid to prevent deterioration in the polyethylene wax according to the present invention.

The fixing resin for use in the toner according to the present invention is exemplified by the following resins.

A homopolymer of styrene or a substituent of styrene, such as poly-p-chlorostyrene or polyvinyl toluene; a styrene copolymer, such as styrene-p-chlorostyrene copolymer, styrene-vinyl toluene copolymer, styrene-vinylnaphthalene copolymer, styrene-acrylic ester copolymer, styrene-methacrylic ester copolymer, styrene-α-chloromethyl methacrylate copolymer, styrene-aclyronitrile copolymer, styrene-vinylmethylether copolymer, styrene-vinylethylether copolymer, styrene-vinylethylketone copolymer, styrene-vinylethylether copolymer, styrene-vinylmethylketone copolymer, styrene-butadiene copolymer, styrene-isoprene copolymer or styrene-acrylonitrile-indene copolymer; polyvinyl chloride, phenol resin, natural denatured phenol resin, natural resin denatured maleic-acid resin, acrylic resin, methacrylic resin, polyvinyl acetate resin, silicon resin, polyester resin, polyurethane, polyamide resin, furan resin, epoxy resin, xylene resin, polyvinylbutyral, terpene resin, chromane-indene resin and petroleum resin. It is preferable that styrene copolymer or polyester resin is employed. Also low moisture absorption resin prepared by graft-polymerizing styrene acrylate to the foregoing polyester resin may be employed. The styrene polymer or the styrene copolymer may be crosslinked or a mixed resins may be employed.

Vinyl copolymer for use in the fixing resin according to the present invention have structural units which may contain a styrene monomer and/or a (metha) acrylate monomer and another vinyl monomer.

The styrene monomer according to the present invention is exemplified by the following materials except for styrene: o-methylstyrene, m-methylstyrene, p-methylstyrene, α-methylstyrene, p-ethylstyrene, 2,4-dimethylstyrene, p-n-butylstyrene, p-ter-butylstyrene, p-n-hexylstyrene, p-n-octylstyrene, p-n-dodecylstyrene, p-methoxystyrene, p-phenylstyrene, p-chlorostyrene and 3, 4-dichlorostyrene.

The acrylate monomer and the methacrylate monomer is exemplified by alkylate of acryic acid or methacrylic acid, such as methyl acrylate, ethyl acrylate, propyl acrylate, n-butyl acrylate, isobutyl acrylate, n-octyl acrylate, dodecyl acrylate, 2-ethylhexyl acrylate, stearyl acrylate, methyl methacrylate, ethyl methacrylate, propyl methacrylate, n-butyl methacrylate, isobutyl methacrylate, n-octyl methacrylate, dodecyl methacrylate or stearyl methacrylate; 2-chloroethyl acylate, phenyl acrylate, α-chloromethyl acrylate, phenyl methacrylate, dimethylaminoethyl methacrylate, diethylaminoethyl methacrylate, 2-hydroxyethyl methacrylate, grycydyl methacrylate, bisgrycydyl methacrylate, polyethylene glycol dimethacrylate and methacryloxyethyl phosphate. In particular, it is preferable that ethyl acrylate, propyl acrylate, butyl acrylate, methyl methacrylate, ethyl methylacrylate, propyl methacrylate or butyl methacrylate is employed.

The other vinyl monomer according to the present invention is exemplified by acrylic acid, such as acrylic acid, methacrylic acid, α-ethylacrylate or crotonic acid, their α-or β-alkyl derivatives, unsaturated dicarboxylic acid, such as fumaric acid, maleic acid, citraconic acid or itaconic acid, their monoester derivatives, their diester derivatives, monoacryloyl oxyethyl succinate, monomethacryloyl oxyethyl succinate, acrylonitrile, methacrylnitril and acrylic amide.

The fixing resin according to the present invention contains the vinyl monomer. The coexistence polymerization for coexisting polyethylene wax according to the present invention is performed in the overall step of the vinyl copolymer or a portion of the same. Thus, the vinyl copolymer in which polyethylene wax is uniformly dispersed can be obtained as at least a component thereof. The vinyl copolymer may partially be crosslinked with a crosslinking material, such as a monomer having two or more polymerizable double bonds, for example, divinyyl benzene, divinyl naphthalene, ethylene glycol dimethacrylate, 1, 3-butanediol dimethacrylate, divinyl aniline, divinyl ether, divinyl sulfide or divinylsulfon.

When an electrification control agent is blended (internally added) in particles of the toner according to the present invention or mixed (externally added) with the same, the amount of electrification of the toner can be controlled to a required value.

The positive electrification control agent for the toner is exemplified by a material denatured by nigrosine or fatty acid metal salt; quaternary ammonium salt, such as tributylbenzyl ammonium-1-hydroxy-4-naphtosulfonate or tetrabutylammonium tetrafluoroborate; onium salt, such as phosphonium salt, which is an analogue of the quaternary ammonium salt; lake pigment of the onium salt; triphenyl methane dye and its lake pigment; metal salt of high fatty acid; diorganotin oxide, such as dibutyl tin oxide, dioctyl tin oxide or dicyclohexyl tin oxide; and diorganotin borate, such as dibutyl tin borate, dioctyl tin borate or dicyclohexyl tin borate. The foregoing material may be employed solely or two or more materials may be mixed. In particular, it is preferable that the electrification control agent, such as nigrosine, quaternary ammonium salt or the triphenol methane dye is employed.

The negative electrification control agent is exemplified by an organic metal complex or a chelate compound as an effective agent. Specifically, amonoazo metal complex, an acetylacetone metal complex, an aromatic hydroxycarboxylate or an aromatic dicarboxylate metal complex may be employed. As an alternative to this, aromatic hydroxycarboxylate, an aromatic monocarboxylate, aromatic polycarboxylate, its metal salt, an anhydride, esters or phenol derivatives, such as bisphenol, may be employed.

It is preferable that the foregoing electrification control agent is internally added to the toner by 0.1 wt. % to 10 wt. % with respect to the fixing resin.

It is preferable that the toner according to the present invention is externally added with fine powder of silica to improve the development characteristics, the fluidity, the electrification stability and the durability. It is preferable that the specific surface area of the fine powder of silica is 30 m²/g or higher owing to absorption of nitrogen measured by a BET method. The fine powder of silica is externally added by a quantity satisfying a range from 0.01 wt. % to 5 wt. % with respect to the toner. If necessary, hydrophobic characteristic is imparted to fine powder of silica by a treatment, such as a variety of organic silicon compound or a variety of treatments. As an alternative to this, the electrification characteristic of fine powder of silica is controlled.

Another additive to be added to the toner is, for example, lubricating powder, such as teflon resin powder, zinc stearate powder or polyvinylidene fluoride. In particular, it is preferable that polyvinylidene fluoride is employed. As an alternative to this, a polishing material, such as cerium oxide which, silicon carbonate powder or strontium titanate powder is employed. In particular, it is preferable that strontium titanate powder is employed. As an alternative to this, a fluidity imparting material, such as titanium oxide powder or aluminum oxide powder may be employed. In particular, it is preferable that a hydrophobic agent is employed. A coagulation preventive material or a conductivity imparting material, such as carbon black powder, zinc oxide powder, antimony oxide powder or tin oxide powder may be employed. As an alternative to this, a reversed-polarity white fine grain or black fine grain may be employed in a small quantity as a material for improving the development characteristic.

When the toner according to the present invention is employed as a binary developer, the toner is mixed with a carrier. In the foregoing case, it is preferable that the mixture ratio of the toner and the carrier is, as the concentration of the toner, 2 wt. % to 10 wt. %. The carrier according to the present invention may be a known carrier. For example, iron powder, ferrite, magnetite, glass beads or a material obtained by processing the surface of the foregoing material with a fluorine resin, vinyl resin or silicon resin may be employed.

Usually, the toner according to the present invention is employed as a binary developer composed of the toner and the carrier. A magnetic material is furthermore contained in the toner as a magnetic toner which is a one-component developer. In the foregoing case, the magnetic material may also serve as coloring matter. In the present invention, the magnetic material to be contained in the magnetic toner is exemplified by an iron oxide, such as magnetite, hematite or ferrite; metal, such as iron, cobalt or nickel; an alloy or a mixed material of the foregoing metal and metal, such as aluminum, cobalt, copper, lead, magnesium, tin, zinc, antimony, calcium, manganese, selenium, titanium, tungsten ,banadium or strontium.

It is preferable that the mean particle size of the magnetic material is 2 μm or smaller, more preferably about 0.1 μm to about 0.5 μm. It is preferable that the quantity of the magnetic material to be contained in the toner is 30 wt. % to 70 wt. % with respect to the fixing resin.

The coloring matter to be employed in the toner according to the present invention is exemplified by a proper pigment or a dye. The coloring matter to be added to the toner is exemplified by the pigment, such as carbon black, aniline black, acetylene black, naphthol yellow, Hansa yellow, rhodamine lake, alizarin lake, iron red, phtnalocyanine blue and indanthrene blue. The quantity of the foregoing coloring matter must be determined to sufficiently maintain the optical density of the fixed image. It is preferable that the coloring matter is added by 0.2 wt. % to 15 wt. % with respect to the resin.

To achieve a similar object, a dye is employed which is exemplified by an azo dye, an anthraquinone dye, a xanthene dye and a methine dye. The dye is added by 0.2 wt. % to 15 wt. % with respect to the resin.

To manufacture the toner for developing electrostatic charges according to the present invention, the fixing resin, the wax, the electrification control material, the pigment or the dye serving as the coloring matter, magnetic powder and, if necessary, another additive are sufficiently mixed by a mixer, such as a Henschel mixer or a Super mixer. Then, a thermal fusing kneader, such as a heated roll, a kneader or an extruder, is used to melt and knead the mixed materials so as to sufficiently mix the materials. Then, pulverization and classification are performed after the temperature has been decreased to obtain toner having a mean particle size of 6 μm to 10 μm. If necessary, a required additive is allowed to adhere to the toner and mixed with the same by a mixer, such as the Henschel mixer. Thus, the toner having the additive externally added thereto can be obtained.

The toner according to the present invention exhibits satisfactory fixing performance when it is employed in the image forming apparatus arranged to visualize an electrostatic latent image formed on a photosensitive member serving as an electrostatic charge holding member by using a binary developer composed of the toner and the carrier. Then, the visualized toner image is transferred to a recording medium, and then the recording medium having the toner image is heated to fix the toner image. As a result, the image forming apparatus can be provided with which the fluidity, the heat resistance, the durability and the preservation stability can be improved, which is able to prevent shortening of the life of the developer caused from the carrier spent occurring due to the toner and shortening of the life of the photosensitive member occurring due to filming of the photosensitive member caused by the toner and which is capable of recording and forming a stable electrostatic toner image.

Examples of the present invention will now be described. Note that the present invention is not limited to the following description.

### EXAMPLE 1

A raw material of toner composed of 86 wt. % of styrene-acryl copolymer resin (CPR100 which was trade name of Mitsui Chemical), 1 wt. % of a metal complex containing chrome (Bontron S-34 which was trade name of Orient Chemical Industry), 8 wt. % of carbon black (MA-100 which was trade name of Mitsubishi Chemical) and 5 wt. % of polyethylene wax (Neowax L which was trade name of Yasuhara Chemical) was previously mixed by a super mixer. Then, a double spindle kneader was operated to fuse the raw material with heat and knead the same, and then the kneaded material was crushed by a jet mill. Then, the crushed material was classified by a dry air-flow classifier so that particles having a means particle size of 9 μm was obtained.

Then, 0.8 wt. % of hydrophobic silica (Aerozil R972 which was trade name of Nihon Aerozil was added to the foregoing particles, then the material was stirred by a Henschel mixer. Thus, the hydrophobic silica was allowed to adhere to the surfaces of the particles so that the toner was obtained.

The foregoing polyethylene wax was a material obtained by refining low-grade polymer of polyethylene prepared by a medium-or low-pressure method polyethylene polymerization method. The foregoing polyethylene wax had a weight average molecular weight/number average molecular weight (Mw/Mn) of 1.86, melt viscosity of 8.6 mPa•s at 140° C., degree of crystallinity of 85%, and the melting point which had a peak of DSC absorbed heating value at 87° C.

### EXAMPLE 2

A raw material of toner composed of 86 wt. % of styrene-acryl copolymer resin (CPR100 which was trade name of Mitsui Chemical), 1 wt. % of a metal complex containing chrome (Bontron S-34 which was trade name of Orient Chemical Industry), 8 wt. % of carbon black (MA-100 which was trade name of Mitsubishi Chemical) and 5 wt. % of polyethylene wax (Neowax AL which was trade name of Yasuhara Chemical) was previously mixed by a super mixer. Then, a double spindle kneader was operated to fuse the raw material with heat and knead the same, and then the kneaded material was crushed by a jetmill. Then, the crushed material was classified by a dry air-flow classifier so that particles having a means particle size of 9 μm was obtained. Then, 0.8 wt. % of hydrophobic silica (Aerozil R972 which was trade name of Nihon Aerozil was added to the foregoing particles, then the material was stirred by a Henschel mixer. Thus, the hydrophobic silica was allowed to adhere to the surfaces of the particles so that the toner was obtained.

The foregoing polyethylene wax was a material obtained by refining low-grade polymer of polyethylene prepared by a medium-or low-pressure method polyethylene polymerization method. The foregoing polyethylene wax had a weight average molecular weight/number average molecular weight (Mw/Mn) of 1.71, melt viscosity of 8.5 mPa•s at 140° C., degree of crystallinity of 83% and the melting point which had a peak of DSC absorbed heating value at 83° C.

### EXAMPLE 3

A raw material of toner composed of 86 wt. % of styrene-acryl copolymer resin (CPR100 which was trade name of Mitsui Chemical), 1 wt. % of ametal complex containing chrome (Bontron S-34 which was trade name of Orient Chemical Industry), 8 wt. % of carbon black (MA-100 which was trade name of Mitsubishi Chemical) and 5 wt. % of polyethylene wax (Neowax LS which was trade name of Yasuhara Chemical) was previously mixed by a super mixer. Then, a double spindle kneader was operated to fuse the raw material with heat and knead the same, and then the kneaded material was crushed by a jetmill. Then, the crushed material was classified by a dry air-flow classifier so that particles having a means particle size of 9 μm was obtained. Then, 0.8 wt. % of hydrophobic silica (Aerozil R972 which was trade name of Nihon Aerozil was added to the foregoing particles, then the material was stirred by a Henschel mixer. Thus, the hydrophobic silica was allowed to adhere to the surfaces of the particles so that the toner was obtained.

The foregoing polyethylene wax was a material obtained by refining low-grade polymer of polyethylene prepared by a medium- or low-pressure method polyethylene polymerization method. The foregoing polyethylene wax had a weight average molecular weight/number average molecular weight (Mw/Mn) of 1.78, melt viscosity of 8.5 mPa•s at 140° C., degree of crystallinity of 82%, and the melting point which had a peak of DSC absorbed heating value at 86° C.

### Comparative Example 1

A process similar to Example 1 was performed except for the polyethylene wax which was not added in this comparative example so that comparative toner was obtained.

### Comparative Example 2

A process similar to Example 1 was performed except for the polyethylene wax which was, in this comparative example, ethylene homopolymer (Polywax 655 which was trade name of Toyo Peterolite) saturated completely and added by 5 wt. % so that comparative toner was obtained. The ethylene homopolymer saturated completely had a weight average molecular weight/number average molecular weight (Mw/Mn) of 1.20, melt viscosity of 6.0 mPa•s at 140° C., degree of crystallinity of 93%, and a melting point which had a peak of DSC absorbed heating value at 93° C.

### Comparative Example 3

A process similar to Example 1 was performed except for Fischer-Tropsch wax (FT100 which was a trade name of Nippon Seiro) which was prepared from natural gas and added by 5 wt. % as a substitute for the polyethylene wax so that comparative toner was obtained. The Fischer-Tropsch wax had a weight average molecular weight/number average molecular weight (Mw/Mn) of 1.17, melt viscosity of 7.8 mPa•s at 140° C., degree of crystallinity of 90%, and the melting point which had a peak of DSC absorbed heating value at 94° C.

### (Comparative Example 4)

A process similar to Example 1 was performed except for Fischer-Tropsch wax (SPRAY30 which was a trade name of Schumann Sazol) manufactured from coal and added by 5 wt. % as a substitute for the polyethylene wax so that comparative toner was obtained. The Fischer-Tropsch wax had a weight average molecular weight/number average molecular weight (Mw/Mn) of 1.36, melt viscosity of 6.9 mpa•s at 140° C., degree of crystallinity of 90%, and the melting point which had a peak of DSC absorbed heating value at 80° C.

The fixing performance and the preservation stability of the toners according to the examples 1-3 and comparative examples 1-4 were evaluated by the following methods.

(1) Non-Offset Temperature Range

An electrophotographic laser beam printer incorporating an organic photoconductive photosensitive member (an OPC) serving as the photosensitive member was operated at a printing speed of 60 sheets/minute (a printing process speed was 26.7 cm/second) under conditions that the potential at which the OPC was electrically charged was −650V, the residual potential was −50V, the development bias potential was −400V and the contrast potential in the development portion was 350V. A development unit incorporated a carrier which was magnetite carrier (having electric resistance of 4.1×10⁸ Ω•cm) coated with silicon resin containing a conductive material and having a weight average particle size of 100 μm. The developer was prepared such that the concentration of the toner was 2.5 wt. %. A magnetic brush development method was employed such that the development gap (the distance from the surface of the photosensitive member to the surface of the development roller) was 0.8 mm. In the development region, the photosensitive member and the development roller were arranged to move in the same direction. Moreover, ratio of the peripheral speeds of the two units (development roller/photosensitive member) was 3. A reversal development was employed to form images.

A fixing unit incorporated a heated roller having an aluminum core coated with a thin fluorine resin (tetrafluoroethylene-perfluoroalkyl vinyl ether copolymer: PFA) tube (having a thickness of 40 μm). The fixing unit incorporated a heater lamp disposed in the central portion thereof. The fixing unit further incorporated a backup roller having an aluminum core provided with a silicon rubber layer (having a thickness of 7 mm) having rubber hardness of about 30°: and a PFA tube coating the outermost layer thereof. The fixing conditions were as follows: the process speed was 26.7 cm/second, the outer diameter of each of the heated roller and the backup roller was 60 mm, the pressing load was 50 kgf and the width of the contact region (a nipping region) between the two units was about 7 mm. The controlled temperature of the heated roller was changed to evaluate the offset in accordance with contamination of a white paper portion of a fixed image at each surface temperature of the heated roller. Although the heated roller was impregnated with silicon oil and provided with a nomex paper winding type cleaner, the cleaner was removed when the offset was evaluated. In a silicon-oil-less state, images were recorded on a thick paper sheet (having a thickness of about 200 μm) and a thin paper sheet (having a thickness of about 100 μm). The low-temperature offset was evaluated with the former paper sheet, while the high-temperature offset was evaluated with the latter paper sheet.

(2) Fixing Strength

The temperature of the surface of the heated roller of the fixing unit was made to be 175° C. A 1 inch×1 inch solid black image and a line drawing recorded on thick paper (having a thickness of about 200 μm) by operating the laser beam 1-on and 4-off were subjected to a tape separation test and a rubbing test were performance. Thus, the fixing strength of the images were evaluated.

The tape separation test was performed such that a Scotch Mending Tape 810 was applied to a solid black image. Then, the densities of the image realized before and after the tape was separated were measured by a reflection densitometer (RD-914 manufactured by Macbeth). Then, the tape separation resistance was obtained in accordance with “tape separation strength (%)=reflection density of solid black image realized after tape was separated/reflection density of solid black image realized before tape was separated×100”.

The rubbing test was performed such that the line drawing was rubbed by a Whatman filter paper 44 with a load of 200 gf. The degree of contamination of the filter paper was evaluated with a whiteness meter. The ratio of the reflectance of the contaminated filter paper and that of non-contaminated filter paper was obtained as a Hunter value (%) so that the rubbing resistance (%) was obtained.

(3) Preservation Stability

The toner was introduced into a metal Schale and the metal Schale was allowed to stand for 24 hours in a desicator having humidity controlled to 91% RH with a humidification material and set to a temperature of 50° C. Thus, the degree of coagulation of the toner was visually evaluated.

Results of the foregoing evaluations of the toners were shown in Table 1A and 1B.

TABLE 1A
Characteristics of Wax Added to Toner

| | | distribution | melt viscosity | | |
|---|---|---|---|---|---|
| | | of molecular | at 140° C. | Melting Point | Degree of |
| | type | weight (Mw/Mn) | (mPa · s) | by DSC (° C.) | crystallinity (%) |
| Example 1 | polyethylene wax | 1.86 | 8.6 | 87 | 85 |
| | (Neowax L) | | | | |
| Example 2 | polyethylene wax | 1.71 | 8.5 | 83 | 83 |
| | (Neowax AL) | | | | |
| Example 3 | polyethylene wax | 1.78 | 8.5 | 86 | 82 |
| | (Neowax LS) | | | | |
| Comparative | no wax | — | — | — | — |
| Example 1 | | | | | |
| Comparative | polyethylene wax | 1.20 | 6.0 | 93 | 93 |
| Example 2 | (Polywax 655) | | | | |
| Comparative | Fischer-Tropsch wax | 1.17 | 7.8 | 94 | 90 |
| Example 3 | (FT100) | | | | |
| Comparative | Fischer-Tropsch wax | 1.36 | 6.9 | 80 | 90 |
| Example 4 | (SPRAY30) | | | | |

TABLE 1B
Fixing Performance and Preservation Stability of Toner

| | non-offset | tape | | preservation |
|---|---|---|---|---|
| | temperature | separation | rubbing | stability |
| | range | strength | resistance | (50° C. × 91 % RH |
| | (° C.) | (%) | (%) | 24 hours) |
| Example 1 | 165 to >220 | 68 | 78 | not coagulated |
| Example 2 | 165 to >220 | 65 | 76 | not coagulated |
| Example 3 | 165 to >220 | 67 | 77 | not coagulated |
| Comparative | no range | 58 | 40 | not coagulated |
| Example 1 | | | | |
| Comparative | 175 to >220 | 48 | 69 | not coagulated |
| Example 2 | | | | |
| Comparative | 185 to >220 | 43 | 68 | not coagulated |
| Example 3 | | | | |
| Comparative | 175 to >220 | 45 | 67 | not coagulated |
| Example 4 | | | | |

As can be understood from the results of the evaluations shown in Table 1A and 1B, the toners according to Examples 1 to 3 of the present invention were free from easy occurrence of offset in a temperature region from low temperatures to high temperatures. Since the non-offset temperature range was large, contamination of the fixed image can be prevented when the temperature of the fixing unit was somewhat changed. The fixing strength when the fixing temperature was 175° C. was such that both of the tape separation resistance and the rubbing resistance were 65% or higher. Thus, the fixing strength satisfactory from a viewpoint of practical use was obtained.

The toners according to comparative examples 1 to 4 encountered easy occurrence of low-temperature offset because the non-offset temperature range was too small. Moreover, satisfactory fixing strength was not obtained. Therefore, the foregoing toners were not employed from a viewpoint of practical use. The toners according to Examples 1 to 3 were used in the foregoing laser beam printer to perform successive printing. Thus, shortening of the life of the developer caused from the carrier spent owing to the toner and that of the life of the photosensitive member caused from filming of the photosensitive member owing to the toner did not take place after 200,000 pages were successively printed. Thus, stable images were obtained.

Next, a method of adding wax to the fixing resin will be discussed.

### EXAMPLE 4

70 parts by weight of styrene,10 parts by weight of methyl methacrylate and 20 parts by weight of n-butyl acrylate were mixed so that resin having a maximal value of the distribution of the molecular weight which was about 500,000 was obtained. Then, a mixture of 200 g of the foregoing resin and 45 g polyethylene wax (Neowax L which was trade name of Yasuhara Chemical) was introduced into a 3-litter separable flask so as to be dissolved with xylene in a quantity of 1 litter. Nitrogen gas was substituted for the gas phase, and then the system was heated to the melting point (135° C. to 145° C.) of xylene.

When xylene reflux occurred, a mixture of 440 g of styrene, 65 g of n-butyl acrylate and 30 g of t-butylperoxy-2-ethylhexanoate serving as the polymerization initiator were dripped in 2.5 hours while stirring the mixture so that the solution was polymerized. In the presence of the polymer having a large molecular weight and the polyethylene wax, the polymer components each having a low molecular weight was polymerized. After the dripping step was completed, maturity was performed for one hour while solution was being stirred at a temperature at which xylene was boiled. While the temperature of the system was being gradually raised to 180° C., xylene serving as the solvent was removed under reduced pressure. Thus, resin HT-1 having a peak of the distribution of the molecular weight of the components having the small molecular weight which was about 8,000 was obtained.

The resin HT-1 contained polyethylene wax by about 6 wt. %. The wax was a material obtained by refining low-grade polymer of polyethylene prepared by a medium-or low-pressure method polyethylene polymerization method. The foregoing polyethylene wax had a weight average molecular weight/number average molecular weight (Mw/Mn) of 1.86, melt viscosity of 8.6 mPa•s at 140° C., degree of crystallinity of 85%, and the melting point which had a peak of DSC absorbed heating value at 87° C.

Then, a raw material of toner composed of 91 wt. % of styrene-acryl copolymer resin HT-1 containing the polyethylene, 1 wt. % of a metal complex containing chrome (Bontron S-34 which was trade name of Orient Chemical Industry) and 8wt. % of carbon black (MA-100which was trade name of Mitsubishi Chemical) was previously mixed by a super mixer. Then, a double spindle kneader was operated to fuse the raw material with heat and knead the same, and then the kneaded material was crushed by a jet mill. Then, the crushed material was classified by a dry air-flow classifier so that particles having a means particle size of 9 μm was obtained.

Then, 0.8 wt. % of hydrophobic silica (Aerozil R972 which was trade name of Nihon Aerozil) was added to the foregoing particles, then the material was stirred by a Henschel mixer. Thus, the hydrophobic silica was allowed to adhere to the surfaces of the particles so that the toner according to the present invention was obtained.

### EXAMPLE 5

A process similar to that according to Example 4 was performed except for the polyethylene wax which was wax (Neowax AL which was trade name of Yasuhara Chemical) which was a material obtained by refining low-grade polymer of polyethylene prepared by a medium- or low-pressure method polyethylene polymerization method. The foregoing wax had a weight average molecular weight/number average molecular weight (Mw/Mn) of 1.71, melt viscosity of 8. 5 mpa•s at 140° C., degree of crystallinity of 83%, and the melting point which had a peak of DSC absorbed heating value at 83° C.

### EXAMPLE 6

A process similar to that according to Example 4 was performed except for the polyethylene wax which was wax (Neowax LS which was trade name of Yasuhara Chemical) which was a material obtained by refining low-grade polymer of polyethylene prepared by a medium- or low-pressure method polyethylene polymerization method. The foregoing wax had a weight average molecular weight/number average molecular weight (Mw/Mn) of 1.78, melt viscosity of 8.5 mpa•s at 140° C., degree of crystallinity of 82%, and the melting point which had a peak of DSC absorbed heating value at 86° C.

### Comparative Example 5

A process similar to that according to Example 4 was performed except for the polyethylene wax which was not added in this comparative example and the coexistence polymerization was not performed so that comparative fixing resin HT-2 was obtained. The maximal value of the distribution of the molecular weight of HT-2 was about 600,000 and the peak of the distribution of the molecular weight of the low molecular weight component was about 8,000. Thus, the distribution of the molecular weight similar to that of HT-1 was obtained.

Then, a raw material of toner composed of 85 wt. % of styrene-acryl copolymer resin HT-2, 1 wt. % of a metal complex containing chrome (Bontron S-34 which was trade name of Orient Chemical Industry), 6 wt. % of polyethylene wax (Neowax L which was trade name of Yasuhara Chemical) according to Example 4 and 8 wt. % of carbon black (MA-100 which was trade name of Mitsubishi Chemical) was previously mixed by a super mixer. Then, a double spindle kneader was operated to fuse the raw material with heat and knead the same, and then the kneaded material was crushed by a jet mill. Then, the crushed material was classified by a dry air-flow classifier so that particles having a means particle size of 9 μm was obtained. Then, 0.8 wt. % of hydrophobic silica (Aerozil R972 which was trade name of Nihon Aerozil) was added to the foregoing particles, then the material was stirred by a Henschel mixer. Thus, the hydrophobic silica was allowed to adhere to the surfaces of the particles so that the toner according to the comparative example was obtained.

### Comparative Example 6

A process similar to that according to Comparative Example 5 was performed except for the polyethylene wax which was polyethylene wax (Neowax AL which was trade name of Yasuhara Chemical) according to Example 5 so that comparative toner was obtained.

### Comparative Example 7

A process similar to that according to Comparative Example 5 was performed except for the polyethylene wax which was polyethylene wax (Neowax LS which was trade name of Yasuhara Chemical) according to Example 6 so that comparative toner was obtained.

The fixing performance and the preservation stability of the toners according to the above described examples and the above described comparative examples were evaluated by the following methods.

(1) Non-Offset Temperature Range

An electrophotographic laser beam printer incorporating an organic photoconductive photosensitive member (an OPC) serving as the photosensitive member was operated at a printing speed of 60 sheets/minute (a printing process speed was 26.7 cm/second) under conditions that the potential at which the OPC was electrically charged was −650V, the residual potential was −50V, the development bias potential was −400V and the contrast potential in the development portion was 350V. A development unit incorporated a carrier which was magnetite carrier (having electric resistance of 4.1×10⁸ Ω•cm) coated with silicon resin containing a conductive material and having a weight average particle size of 100 μm. The developer was prepared such that the concentration of the toner was 2.5 wt. %. A magnetic brush development method was employed such that the development gap (the distance from the surface of the photosensitive member to the surface of the development roller) was 0.8 mm. In the development region, the photosensitive member and the development roller were arranged to move in the same direction. Moreover, ratio of the peripheral speeds of the two units (development roller/photosensitive member) was 3. A reversal development was employed to form images.

A fixing unit incorporated a heated roller having an aluminum core coated with a thin fluorine resin (tetrafluoroethylene-perfluoroalkyl vinyl ether copolymer: PFA) tube (having a thickness of 40 μm) . The fixing unit incorporated a heater lamp disposed in the central portion thereof. The fixing unit further incorporated a backup roller having an aluminum core provided with a silicon rubber layer (having a thickness of 7 mm) having rubber hardness of about 30°: and a PFA tube coating the outermost layer thereof. The fixing conditions were as follows: the process speed was 26.7cm/second, the outer diameter of each of the heated roller and the backup roller was 60 mm, the pressing load was 50 kgf and the width of the contact region (a nipping region) between the two units was about 7 mm. The controlled temperature of the heated roller was changed to evaluate the offset in accordance with contamination of a white paper portion of a fixed image at each surface temperature of the heated roller. Although the heated roller was impregnated with silicon oil and provided with a nomex paper winding type cleaner, the cleaner was removed when the offset was evaluated. In a silicon-oil-less state, images were recorded on a thick paper sheet (having a thickness of about 200 μm) and a thin paper sheet (having a thickness of about 100 μm). The low-temperature offset was evaluated with the former paper sheet, while the high-temperature offset was evaluated with the latter paper sheet.

(2) Fixing Strength

The temperature of the surface of the heated roller of the fixing unit was made to be 175° C. A 1 inch×1 inch solid black image and a line drawing recorded on thick paper (having a thickness of about 200 μm) by operating the laser beam 1-on and 4-off were subjected to a tape separation test and a rubbing test were performance. Thus, the fixing strength of the images were evaluated.

The tape separation test was performed such that a Scotch Mending Tape 810 was applied to a solid black image. Then, the densities of the image realized before and after the tape was separated were measured by a reflection densitometer (RD-914 manufactured by Macbeth) . Then, the tape separation resistance was obtained in accordance with “tape separation strength (%)=reflection density of solid black image realized after tape was separated/reflection density of solid black image realized before tape was separated×100”.

The rubbing test was performed such that the line drawing was rubbed by a Whatman filter paper 44 with a load of 200 gf. The degree of contamination of the filter paper was evaluated with a whiteness meter. The ratio of the reflectance of the contaminated filter paper and that of non-contaminated filter paper was obtained as a Hunter value (%) so that the rubbing resistance (%) was obtained.

(3) Preservation Stability

The toner was introduced into ametal Schale and the metal Schale was allowed to stand for 24 hours at a temperature of 50° C. in a desicator having humidity controlled to 91% RH with a humidification material. Thus, the degree of coagulation of the toner was visually evaluated.

(4) Fluidity

Toner in a quantity of 4 g was enclosed in a funnel for measuring fluidity of metal powder (incorporating an orifice having a diameter of 2.63 mm and a length of 3.2 mm and structured such that the conical angle of the funnel was 60°30′) conforming JIS-Z-2502 such that the orifice was closed. Then, the funnel was vibrated, and then the orifice was opened to drop the toner. Time required for the toner to drop was evaluated as the fluidity of the toner. The fluidity was good in inverse proportion to the time required for the toner to be dropped.

(5) Life of Developer

A nomex paper winding type cleaner impregnated with silicon oil was provided for the heated roller of the foregoing laser beam printer. The temperature of the surface of the heated roller was made to be 180° C. to perform a successive printing test by making 50,000 pages of prints. A small quantity of the developer was obtained from the development unit to measure the quantity of the carrier spent caused by the toner. The quantity of the carrier spent was evaluated such that a carbon analyzer in metal (EMIA-110 manufactured by Horiba) to measure the amount (%) of carbon per unit weight of the used carrier from which the toner was removed and the non-used carrier. The difference was evaluated.

Results of the foregoing evaluations of the toners were shown in Table 2A and 2B.

TABLE 2A
Characteristics of Wax Added to Toner

| | type of wax | distribution | melt viscosity | Melting Point | |
|---|---|---|---|---|---|
| | (method of adding | of molecular | at 140° C. | by DSC | Degree of |
| | to fixing resin) | weight (Mw/Mn) | (mPa · s) | (° C.) | Crystallinity (%) |
| Example 4 | Neowax L | 1.86 | 8.6 | 87 | 85 |
| | (coexistence | | | | |
| | polymerization) | | | | |
| Example 5 | Neowax AL | 1.71 | 8.5 | 83 | 83 |
| | (coexistence | | | | |
| | polymerization) | | | | |
| Example 6 | Neowax LS | 1.78 | 8.5 | 86 | 82 |
| | (coexistence | | | | |
| | polymerization) | | | | |
| Comparative | Neowax L | 1.86 | 8.6 | 87 | 85 |
| Example 5 | (kneading | | | | |
| | to fuse) | | | | |
| Comparative | Neowax AL | 1.71 | 8.5 | 83 | 83 |
| Example 6 | (kneading | | | | |
| | to fuse) | | | | |
| Comparative | Neowax LS | 1.78 | 8.5 | 86 | 82 |
| Example 7 | (kneading | | | | |
| | to fuse) | | | | |

TABLE 2B
Characteristics of Toner

| | non-offset | tape | | | carrier | preservation stability |
|---|---|---|---|---|---|---|
| | temperature | separation | rubbing | fluidity | spent | (50° C. × 91 % RH |
| | range (° C.) | strength (%) | resistance (%) | (s/4 g) | (wt %) | 24 hours) |
| Example 4 | 170 to >220 | 72 | 75 | 28.5 | 0.02 | not coagulated |
| Example 5 | 170 to >220 | 70 | 73 | 27.5 | 0.04 | not coagulated |
| Example 6 | 170 to >220 | 71 | 74 | 29.4 | 0.03 | not coagulated |
| Comparative | 165 to >220 | 68 | 78 | 36.5 | 0.10 | not coagulated |
| Example 5 | | | | | | |
| Comparative | 165 to >220 | 65 | 76 | 37.0 | 0.13 | not coagulated |
| Example 6 | | | | | | |
| Comparative | 185 to >220 | 67 | 77 | 35.5 | 0.12 | not coagulated |
| Example 7 | | | | | | |

As can be understood from the results of the evaluations shown in Table 2A and 2B, the toners according to Examples 4 to 6 of the present invention were free from easy occurrence of offset in a temperature region from low temperatures to high temperatures. Since the non-offset temperature range was large, contamination of the fixed image can be prevented when the temperature of the fixing unit was somewhat changed. The fixing strength when the fixing temperature was 175° C. was such that both of the tape separation resistance and the rubbing resistance were 70% or higher. Thus, the fixing strength satisfactory from a viewpoint of practical use was obtained. Moreover, it was realized that the fluidity of the toner is satisfactory, that an amount of the carrier spent is low, and that preservation stability was excellent. On the other hand, the toners according to Comparative Examples 5 to 7 resulted in large non-offset temperature ranges for the toners and satisfactory fixing strength. However, the fluidity of the toners was unsatisfactory and the amount of the carrier spent was excessive. As a result, reliability and the life of the developers were unsatisfactory and the toners were not suitable for the practical use.

The toners according to Examples 4 to 6 were used in the foregoing laser beam printer to perform successive printing. Thus, shortening of the life of the developer caused from the carrier spent owing to the toner and that of the life of the photosensitive member caused from filming of the photosensitive member owing to the toner did not take place after 300,000 pages were successively printed. Thus, stable images were obtained.

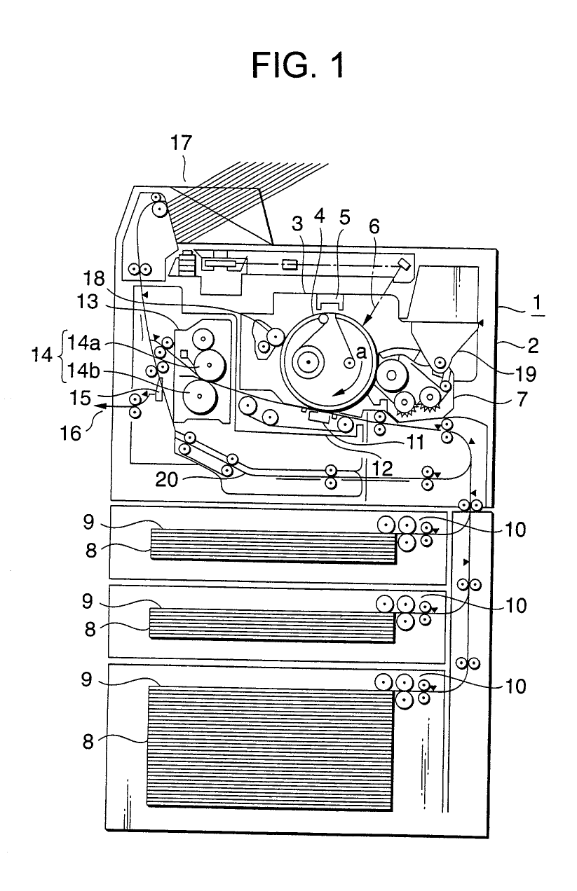

The structure of the laser beam printer will now be described with reference to FIG. 1.

Reference numeral 1 represents a body of the apparatus. The body 1 incorporates a printing portion 3 which can be drawn from a frame 2. Reference numeral 4 represents a photosensitive drum on which a toner image is recorded and formed by a known electrophotographic process and which is supported by a support shaft in such a manner that the photosensitive drum 4 is rotated at predetermined velocity in a direction indicated with an arrow a.

An electric charger 5 is disposed opposite to the surface of the photosensitive drum 4 to uniformly charges the surface of the photosensitive drum 4 which passes to be opposite to the electric charger 5. A laser beam 6 for exposing the surface of the photosensitive drum 4 charged uniformly is used to form an electrostatic latent image on the surface of the photosensitive drum 4 in response to a print information signal supplied from an information processing apparatus.

A development unit 7 is disposed opposite to the surface of the photosensitive drum 4 on which the electrostatic latent image has been formed. The development unit 7 has a development function for forming a toner image by causing the foregoing toner to adhere to the surface of the photosensitive drum 4 by an electrostatic force of the electrostatic latent image .

A cassette 8 accommodates sheet recording mediums (paper sheets) 9 for use in an image printing operation for transferring and fixing the toner image, the paper sheets 9 being stacked when they have been accommodated. A paper feeding roller mechanism 10 constituting a portion of a recording member moving means extracts the paper sheet 9 from the cassette 8 to feed the paper sheet 9 to the photosensitive drum 4.

The paper sheet 9 fed from the paper feeding roller mechanism 10 is brought into contact with the surface of the photosensitive drum 4 such that the toner image can be transferred to the surface of the paper sheet 9. The transfer unit 11 imparts a charge, the polarity of which is opposite to that of the toner image, to the rear surface of the PAPER SHEET 9 which has been brought into contact with the surface of the photosensitive drum 4. Thus, an electrostatic force is generated which transfers the toner image formed on the surface of the photosensitive drum 4 to the paper sheet 9.

A conveying belt 12 constituting a portion of a paper conveying means conveys the paper sheet 9, on which the toner image has been formed, to a contact type heating fixing unit 13 to be fixing means. A fixing roller 14 forming a pair composed of a heated roller 14a and a backup roller 14b positioned in hermetic contact with each other heats and pressurizes the paper sheet 9 to fix the toner image on the surface of the paper sheet 9.

The paper sheet 9 moved from the fixing unit 13 is discharged to a discharge portion 16 or a discharge portion 17 in accordance with the position of a paper-passage switching member 15. As an alternative to this, the paper sheet 9 moved from the fixing unit 13 is moved to an intermediate position of a passage which reaches the discharge portion 17. Then, the paper sheet 9 is conveyed to a perfect printing paper passage 20 at predetermined timing. Thus, the printed paper having the printed right side is again supplied to the printing portion 3 so that the reverse side of the paper sheet is printed.

Referring to FIG. 1, reference numeral 18 represents a cleaning unit for removing foreign matter, such as toner and paper dust, left on the surface of the photosensitive drum 4 allowed to pass through the transfer unit 11. Reference numeral 19 represents a toner supply unit for supplying the toner to the development unit 7 as necessary.

In FIG. 1, the laser beam printer is shown which incorporates the development unit having one development roller. A development unit incorporating two or more development rollers maybe employed. A laser beam printer may be employed which has a center-feed development unit incorporating a development roller which is rotated in the same direction as the direction in which the photosensitive drum is rotated and a development roller which is rotated in a direction opposite to the direction in which the photosensitive drum is rotated.

As described above, according to the present invention, toner excellent in the fluidity, the durability and the preservation stability and capable of reducing the energy required to fix an image and the image forming apparatus using the toner can be provided.

What is claimed is:

1. Toner for developing an electrostatic charge, comprising:
fixing resin; and
wax,
wherein the wax includes polyethylene wax having a weight average molecular weight/number average molecular weight (Mw/Mn value) of larger than 1.5, a melt viscosity lower than 10 mPa•s at 140° C., and a degree of crystallinity lower than 90%.

2. The toner for developing the electrostatic charge image according to claim 1, wherein the wax has a melting point of from 70° C. to 110° C., the melting point being defined by a maximum peak of an absorbed heating value curve of a DSC curve measured by a differential scanning calorimeter when the temperature is raised.

3. An image forming apparatus comprising:
toner for developing an electrostatic charge image, the toner comprising fixing resin and polyethylene wax having a weight average molecular weight/number average molecular weight (Mw/Mn value) of larger than 1.5, a melt viscosity lower than 10 mPa•s at 140° C., and a degree of crystallinity lower than 90%;
an electrostatic-charge holding member holding an electrostatic latent image;
development unit adapted to supply the toner to the electrostatic-charge holding member to visualize the electrostatic latent image into a toner image;
transfer unit adapted to transfer the toner image formed on the electrostatic-charge holding member to a recording medium; and
fixing unit adapted to fix the toner image to the recording medium by supplying at least heat to the recording medium holding the toner image.

4. The image forming apparatus according to claim 3, wherein the fixing unit is a contact type heating fixing unit.

5. The toner for developing the electrostatic charge image according to claim 1, wherein the polyethylene wax is a polyethylene wax obtained by refining a low-grade polymer of polyethylene prepared by one of a low-pressure method polyethylene polymerization method and a medium-pressure method polyethylene polymerization method.

6. The toner for developing the electrostatic charge image according to claim 1, wherein the fixing resin includes a vinyl copolymer polymerized in a presence of polyethylene wax obtained by refining a low-grade polymer of polyethylene prepared by one of a low-pressure method polyethylene polymerization method and a medium-pressure method polyethylene polymerization method.
